(19) United States
(12) Patent Application Publication
(10) Pub. No.: US 2025/0010606 A1
(43) Pub. Date: Jan. 9, 2025

(54) MULTIPLE COMPONENT APPARATUS FOR BROADENING ITEMS AVAILABLE FOR FLATBED PRINTING

(71) Applicants: James Camron Smalley, Orlando, FL (US); James Edwin Smalley, JR., Orlando, FL (US)

(72) Inventors: James Camron Smalley, Orlando, FL (US); James Edwin Smalley, JR., Orlando, FL (US)

(21) Appl. No.: 18/513,523

(22) Filed: Nov. 18, 2023

Related U.S. Application Data
(60) Provisional application No. 63/384,471, filed on Nov. 21, 2022.

(51) Int. Cl. B41F 15/36

(52) U.S. Cl. CPC B41F 15/36

(57) ABSTRACT

An apparatus for printing onto cups with extruding portions and additional periphery objects via flatbed printing devices. Consisting of a pair of inserts that are used to fasten to a rotary rack, which additionally provides a method for holding a roller that is used to convert the linear motion of a flatbed printer into rotational motion and convey it to a bracket assembly that is used for multiple purposes of which printing on cups with extruding portions is the primary objective, by which the bracket assembly contains a method for adjusting to a variety of cup sizes. Additionally, a further objective is to provide the capability to print onto planar objects, and traditional flatbed printer items, without needing to remove the apparatus from the printer.

### CROSS-REFERENCE TO RELATED APPLICATIONS

This application is a continuation of Provisional U.S. Patent Application Ser. No. 63/384,471, filed Nov. 21, 2022.

### FIELD OF THE INVENTION

The present invention relates to an apparatus for printing an image across the circumferential area of a cup with an extruding portion or a traditional planar object utilizing a flatbed printing device. More particularly, the invention relates to an apparatus that attaches to a rotary rack and is used with a flatbed printer to allow for printing onto cups with extruding portions and additional periphery objects.

### BACKGROUND OF THE INVENTION

With the development of fast-curing flatbed printers capable of printing color-rich textured or embossed features, there has been a significant increase of a sector of print shops dedicated to printing designs directly onto accessories, giftware, ceramics, and many more products. These objects are planar in geometry and easily compatible with a stock flatbed printer setup.

Current methods for decorating the surfaces of cups with extruding portions, such as mugs or tumblers with handles, include processes like vacuum sublimation, silk screen printing, and direct application of a decal.

Currently, designs are not available that allow for the conversion of a flatbed printer to be capable of printing onto cups with extruding portions as the extruding portion hits the bed of the printer preventing full rotation of the cup. The present invention seeks to remedy this by acting as an accessory to a rotary rack [a piece of equipment used with flatbed printers to allow for printing on cylindrical objects by converting the linear motion of the flatbed into rotational motion in the rotary rack roller] to enable printing upon cups with extruding portions and other periphery objects.

### BRIEF SUMMARY OF THE INVENTION

The present invention addresses the problems described above by providing an apparatus for use with currently marketed flatbed printers, acting as an accessory to a rotary rack, allowing for printing onto cups with extruding portions and other periphery objects via flatbed printing devices.

A system, according to a preferred embodiment of the invention, includes inserts that are used to interface with a rotary rack, allowing for the fastening of the current design to a rotary rack such that it acts as an accessory to the rotary rack. While attached, the present invention provides the capabilities to interact with a flatbed printer using a roller that rests on top of the bed of the printer. O-rings set within grooves of the roller touch the table, and as the table moves so too does the roller by way of the rolling friction from the O-rings resting on the table. This roller then has secondary O-rings, longer than the aforementioned O-rings set upon the grooves of the roller, used to transfer the rotational motion from the roller to the upper rack portion of the present invention.

The upper rack has a multitude of features, primarily of which is the ability to allow for printing onto cups with extruding portions. To do so, rails on the present invention are used to mount length adjuster bars. These bars serve two purposes: adjusting for different length objects, and mounting accessories. The present invention describes an accessory that is mounted to the length adjuster bar that is used in part for printing upon cups with extruding portions [i.e., a mug as a non-limiting example]. This accessory is known as the cup bracket and consists of an L-bracket that mounts to the length adjuster bar. The L-bracket has mounting locations on the front face where bearing housings are fastened to. These bearing housings contain a ball-bearing that has a cup roller inserted. On the opposite side of a bearing housing, an end cap is used to secure the cup roller such that it is secured into the ball-bearing allowing for smooth rotation of the cup roller. A pair of cup rollers are used to hold one end of the cup. To facilitate the rotation of the cup, the aforementioned long O-ring is used to transfer motion from the roller to one of the cup rollers enabling the held cup to rotate. Finally, two of the aforementioned cup brackets are used to hold a single cup; where one end of the cup rests on a pair of cup rollers of one cup bracket, and the other end rests on another pair of cup rollers on the other cup bracket. The space between the cup brackets is empty allowing for an extruding portion [i.e., a handle as a non-limiting example] to rotate without crashing into the bed of the printer.

An additional feature of the cup bracket is the clamp mounts. These are primarily used to secure the cup in place so that it does not move back and forth during printing. However, these clamps can also be used to secure objects that do not need to be printed using rotational motion, allowing for the flatbed printer to be used normally without needing to remove the rotary rack from the printer.

Additional measures have also been taken so that the present invention is compatible with stock items of a rotary rack, with the slots and holes on the sides of the inserts allowing for the use of items normally used with the rotary rack.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 shows the overall assembly for the present invention.

FIG. 2 shows the left insert that is used to attach to the rotary rack, and additionally holds the roller that converts the linear motion of the bed into rotational motion.

FIG. 3 shows the right insert that is used to attach to the rotary rack, and additionally holds the roller that converts the linear motion of the bed into rotational motion.

FIG. 4 shows the front and rear mounting rails, which provide a means to mount the cup length adjuster.

FIG. 5 shows the driving roller that is used to interact with the flatbed to transfer linear motion into rotational motion.

FIG. 6 shows the cup length adjuster that allows for the adjustment of various cup lengths.

FIG. 7 shows the cup bracket assembly.

FIG. 8 shows the cup L-bracket that is used with the bearing housing to adjust for a variety of cup diameters.

FIG. 9 shows the cup guide which acts to keep a cup in place or to hold an object that does not need to be rotated [acting similarly to a vise].

FIG. 10 shows the bearing housing that is used to adjust for different diameter cups and smooth the rotational motion.

FIG. 11 shows the cup roller that the held cup rests upon, allowing for rotation of the cup on the roller connectors.

FIG. 12 shows an end cap that is used for fastening the roller connection to the bearing housing.

### DETAILED DESCRIPTION OF THE INVENTION

Reference will now be made to a preferred embodiment of the invention, non-limiting examples of which are illustrated in accompanying drawings.

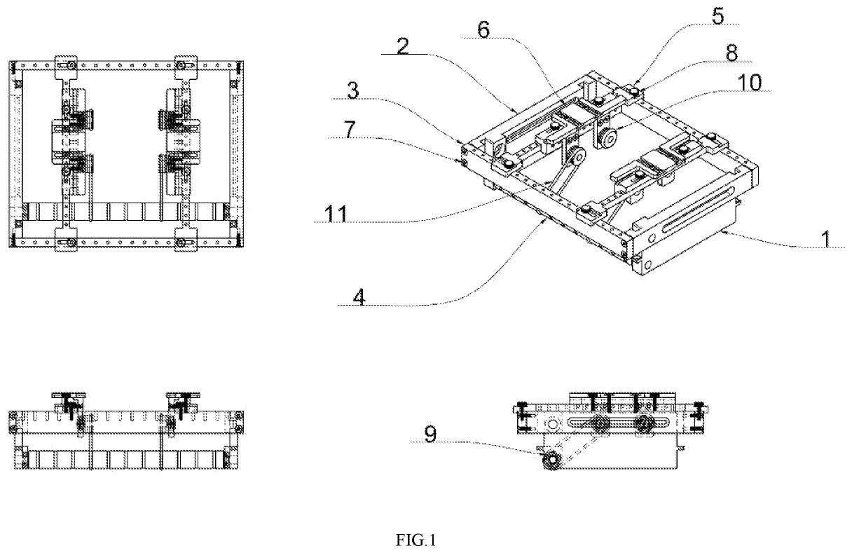

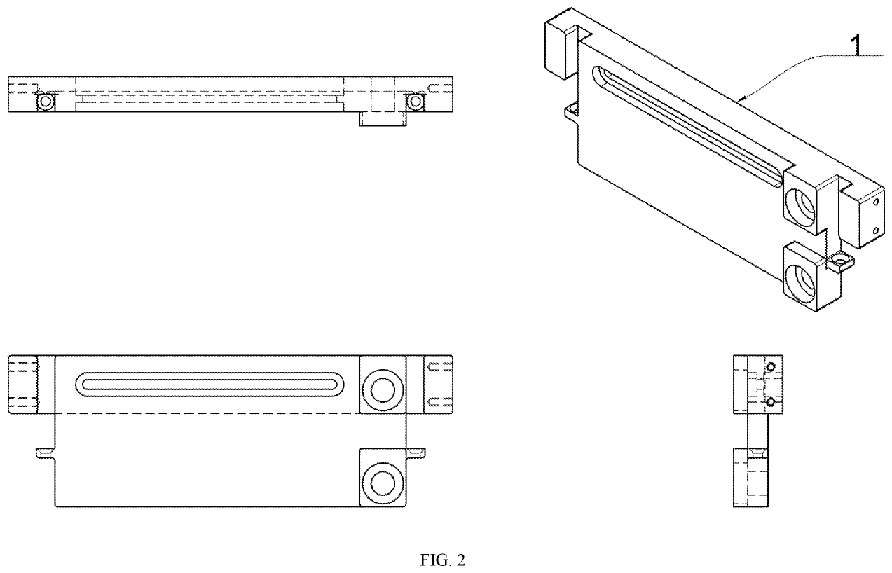

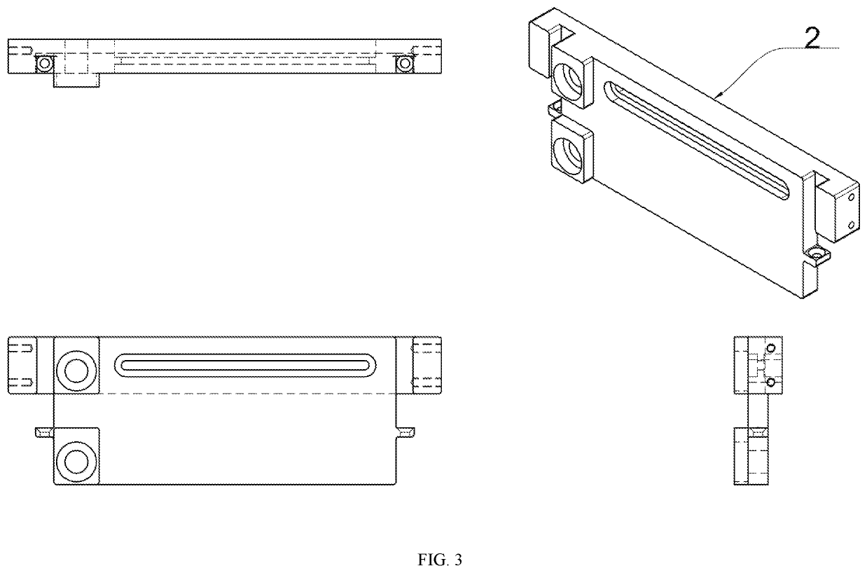

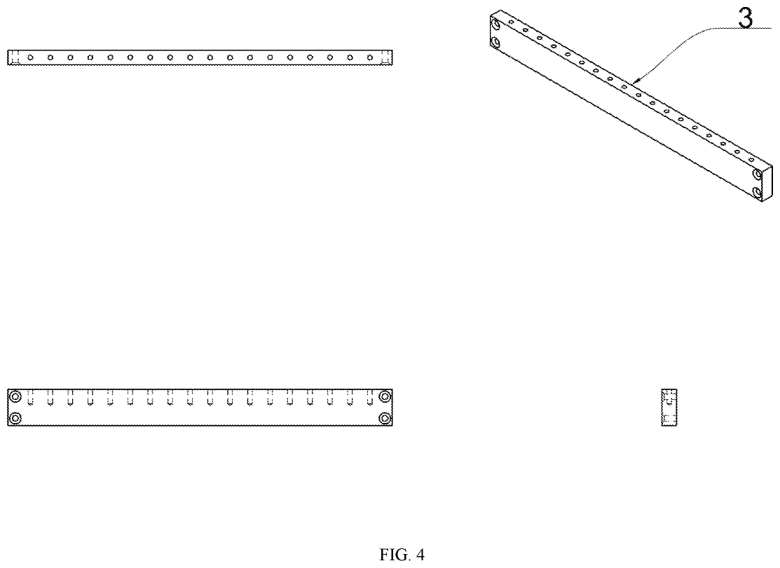

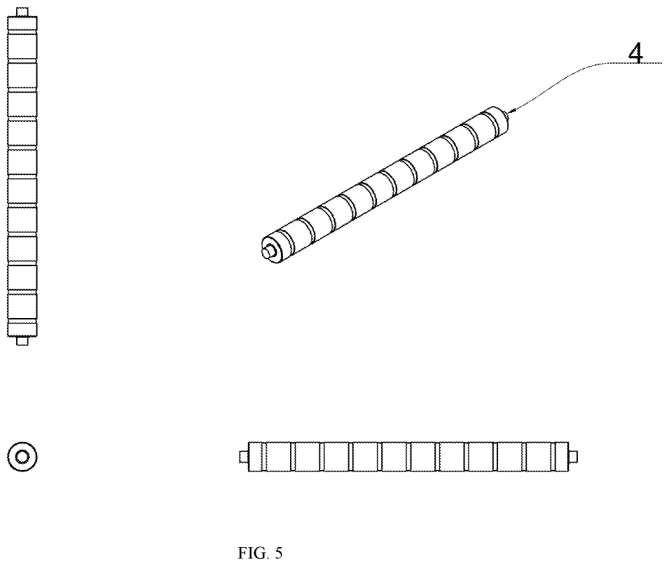

In FIG. 1, an apparatus for printing onto cups with extruding portions and additional periphery objects is shown. The left insert 1 and right insert 2 are used to interact with a rotary rack, and additionally feature optional slots and holes such that equipment standard to a rotary rack can be used with the present invention. The left insert 1 and right insert 2 are shown more specifically in FIG. 2 and FIG. 3 respectively. These inserts 1,2 are mirrors of each other and are identical in overall purpose, for attaching to the rotary rack and providing a frame for the structure of the present invention. Tabs on the side of the inserts 1,2 are used with fasteners from the rotary rack to mount the present invention onto the rotary rack. On each of the inserts 1,2 exists two housings for press-fitting ball-bearings 9. These ball-bearings 9 are used to hold and smoothly rotate the driving roller 4, shown in FIG. 5. The driving roller 4 is inserted into the ball-bearings 9 within the inserts, and the driving roller 4 then sits tangent to the surface of the flatbed printer, allowing for any linear motion of the flatbed to be transferred to rotational motion in the driving roller 4. To secure the assembly, the roller table front and rear 3, shown in FIG. 4, are attached to the front and back of the inserts 1,2 using fasteners 7. With this, the assembly of the frame is complete.

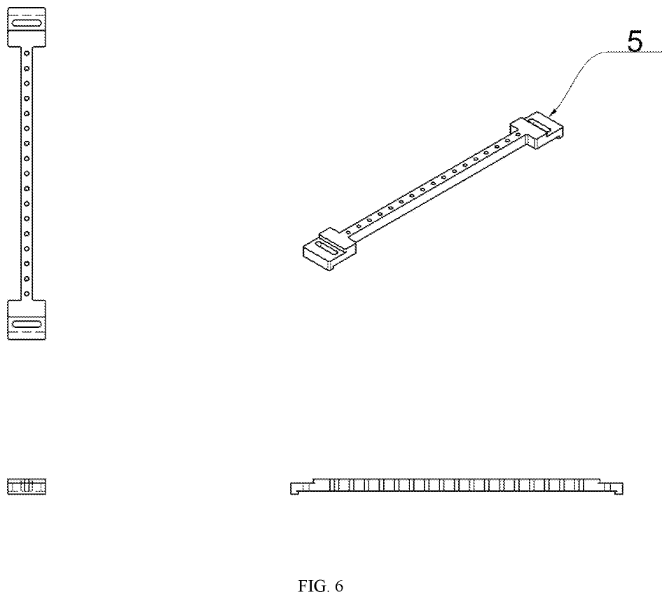

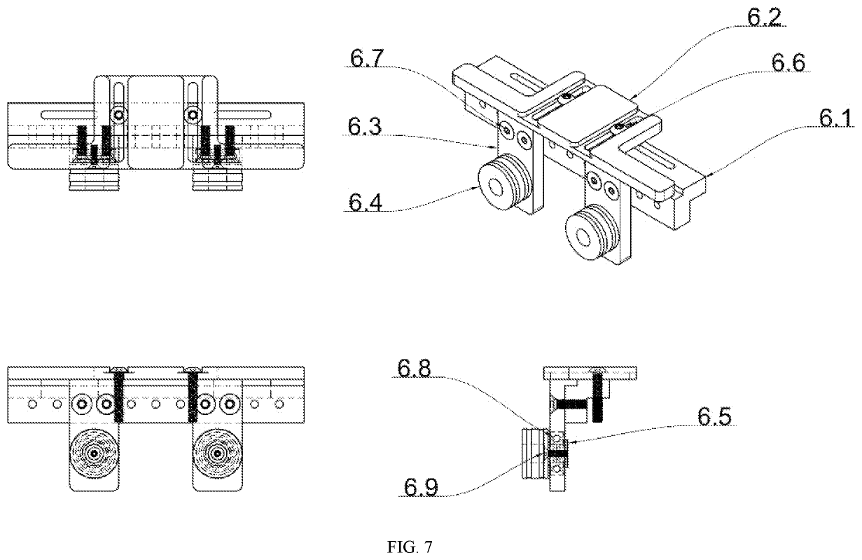

Sliding along the length of the roller table front and rear 3 cup length adjusters 5, shown in FIG. 6, are mounted and attached with thumb screws 8. The cup length adjusters 5 allow for the mounting of equipment and are used to adjust for different sized cups and peripheral items. Fastening to the cup length adjusters 5, using thumb screws 8, are the cup bracket assemblies 6, shown in FIG. 7, used for holding the cups with extruding portions and other periphery objects.

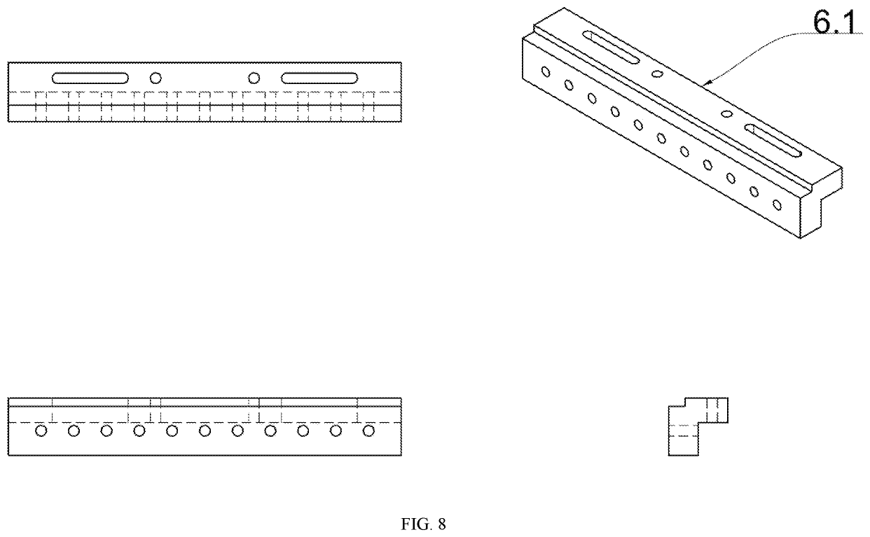

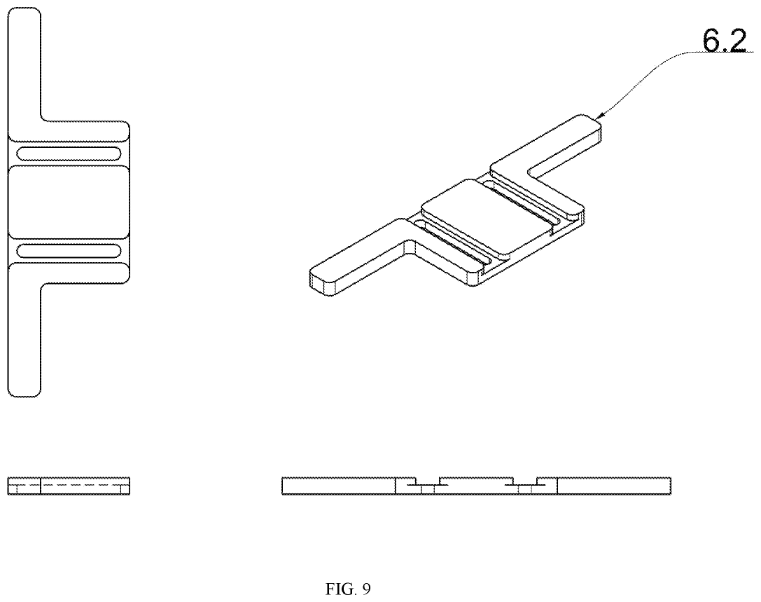

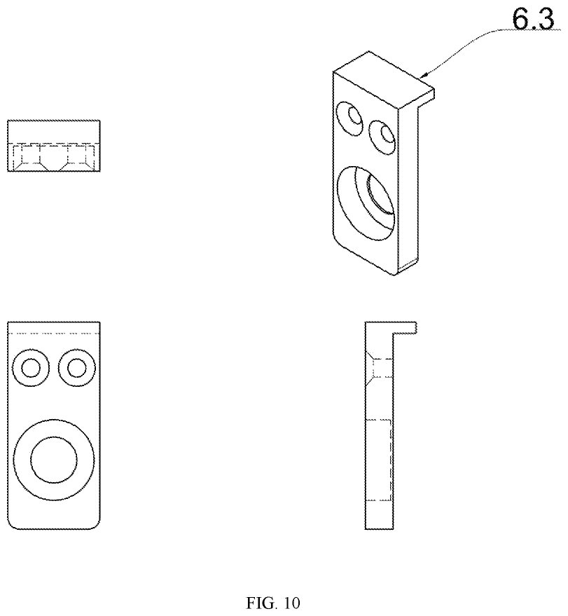

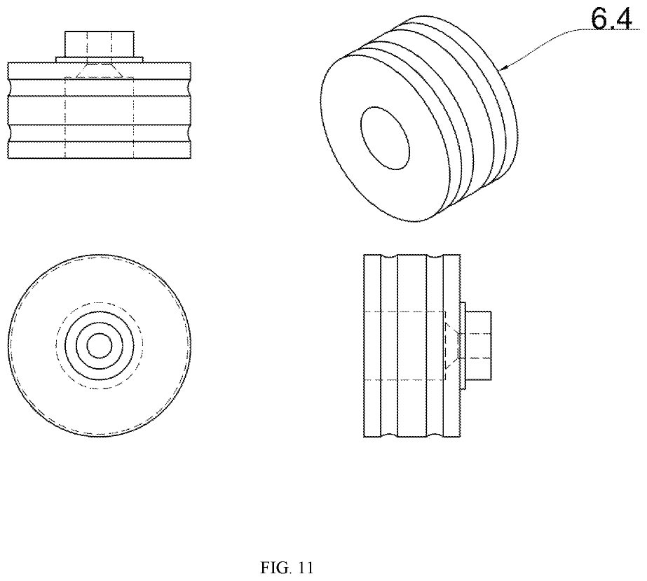

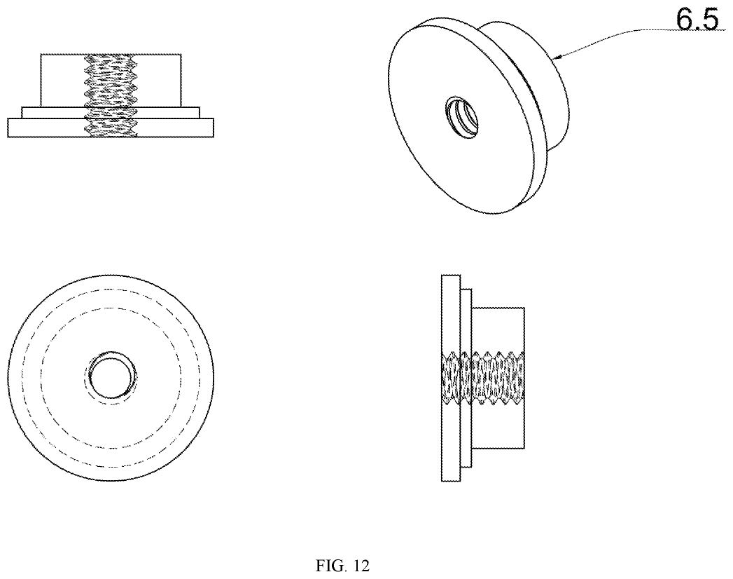

The cup bracket assembly 6 is first composed of the cup L-bracket 6.1, as shown in FIG. 8. The cup L-bracket 6.1 mounts to the cup length adjuster 5 and provides mounting locations to adjust for different cup diameters. Connecting to the cup L-bracket 6.1 is the cup guide 6.2, as shown in FIG. 9. The cup guide 6.2 has a variety of uses: providing support for a held cup by preventing miniscule movements to increase print quality, or for holding planar objects that do not need to be rotated by clamping the objects between two cup guides 6.2, allowing for the present invention to act as a traditional flatbed printing device without need for uninstallation from the flatbed printer. The cup guide 6.2 is attached to the cup L-bracket 6.1 using fasteners 6.6, and these same fasteners 6.6 are used to adjust the position of the cup guide 6.2 for supporting cups or gripping planar objects. Continuing, the cup bracket assembly 6 contains the bearing housing 6.3, shown in FIG. 10. The bearing housing 6.3 contains a ball-bearing 6.8 along with the cup roller 6.4, shown in FIG. 11, that is mounted into the bearing housing 6.3 by means of a fastener 6.9 going into the end cap 6.5, shown in FIG. 12, allowing for the cup roller 6.4 to freely rotate by means of the ball-bearing 6.8 within the bearing housing 6.3. The bearing housing 6.3 is then mounted to the cup bracket 6.1 using fasteners 6.7. This is done four times, twice for each cup bracket assembly 6. Allowing for a cup with extruding portions to be placed along the cup rollers 6.4 at the edges of the cup, such that the extruding portion is now between the two cup bracket assemblies 6 and sitting in the space created by the inserts 1,2 without hitting the flatbed. As mentioned, the bearing housing 6.3 can be adjusted with the fasteners 6.7 to different hole locations on the L-bracket 6.1 to allow for holding a variety of different diameter cups with extruding portions, while the cup length adjusters 5 can be moved along the length of the roller table front and rear 3 to allow for holding different lengths of items. With this, the cup bracket assembly 6 is complete.

To allow for the rotation of the cup when it is set upon the cup rollers 6.4, O-rings 11 are used to transfer motion. An O-ring 11 connection from the driving roller 4 to a cup roller 6.4 of a cup bracket assembly 6 is made. This O-ring 11 provides grip for the driving roller 4 when it is on the bed of the printer, enabling rotation, and transfers the rotational motion to the cup rollers 6.4 as previously mentioned. Additional O-rings 10 are used on both the grooves of the driving roller 4 to provide additional grip and on the grooves of the cup roller 6.4 to provide grip on the object being rotated.

What is claimed is:

1. A flatbed printing apparatus comprising: an insert, a driving roller secured to said inserts, a length adjusting frame that secures to said inserts, a bracket assembly that attaches to said length adjusting frame, a guide that mounts to said bracket assembly, and a cup roller that mounts to said bracket assembly.

2. The flatbed printing apparatus, as in claim 1, wherein said inserts provide mounting for said driving roller into a bearing element.

3. The flatbed printing apparatus, as in claim 1, wherein said driving roller has a cylindrical body such that the surface of said driving roller is tangent to that of the flatbed to transfer motion from the flatbed to the roller.

4. The flatbed printing apparatus, as in claim 1, wherein said inserts provide mounting for said length adjusting frame that is offset from the flatbed, providing adjustability for said bracket assembly along the length of said length adjusting frame.

5. The flatbed printing apparatus, as in claim 1, wherein said bracket assembly provides resting points for supporting objects via said cup rollers and adjustments for varying widths.

6. The flatbed printing apparatus, as in claim 1, wherein said cup roller is connected to said driving roller via an O-ring to transfer motion from said driving roller to said cup rollers within said bracket assembly.

7. The flatbed printing apparatus, as in claim 1, wherein the guide is adjustable within said backet assembly for supporting objects via clamping.
